(19) United States
(12) Patent Application Publication
(10) Pub. No.: US 2004/0069782 A1
(43) Pub. Date: Apr. 15, 2004

(54) Filler neck

(76) Inventors: Natsushi Miura, Aichi-ken (JP); Tomokazu Hori, Aichi-ken (JP); Zenichi Yasuda, Aichi-ken (JP)

Correspondence Address: POSZ & BETHARDS, PLC, 11250 ROGER BACON DRIVE, SUITE 10, RESTON, VA, 20190, US

(21) Appl. No.: 10/680,118

(22) Filed: Oct. 8, 2003

(30) Foreign Application Priority Data
Oct. 9, 2002 (JP) 2002-296025

(51) Int. Cl. B65B 3/00; B67C 3/00; B65D 49/00

(52) U.S. Cl. 220/86.2

(57) ABSTRACT

A filler neck includes a neck body made from resin, a retainer made of metal, and a sealing member securing a sealing property between the neck body and the retainer. The neck body has an upstream end, a fuel supply opening opened at the upstream end, a downstream end communicating with a fuel tank, an outer peripheral surface, an inner peripheral surface, and a flange disposed on the outer peripheral surface and being fixed to a vehicle-side member. The fuel supply opening is opened and closed by a fuel cap. The retainer has an engagement portion and an outer peripheral surface, and is fastened to the fuel cap. The engagement portion is engaged with the neck body. The sealing member is disposed between the inner peripheral surface of the neck body and the outer peripheral surface of the retainer.

### BACKGROUND OF THE INVENTION

1. Field of the Invention

The present invention relates to a filler neck. More particularly, it relates to a filler neck having a fuel supply opening at the upstream end, fuel supply opening into which fuel supply guns are fitted, and communicating with fuel tanks at the downstream end.

2. Description of the Related Art

Japanese Unexamined Patent Publication (KOKAI) No. 2002-87,079 and Japanese Unexamined Patent Publication (KOKAI) No. 9-76,773 discloses conventional filler necks. For example, in the conventional filler neck set forth in Japanese Unexamined Patent Publication (KOKAI) No. 2002-87,079, an O-ring is disposed between the outer peripheral surface of a neck body and the inner peripheral surface of a retainer. FIG. 8 illustrates an axial cross-sectional view of the conventional filler neck disclosed in the patent publication. As illustrated in the drawing, a filler neck 100 is provided with a neck body 101 made from resin, a retainer 103 made of metal and an O-ring 104.

A fuel supply opening 105 is opened at the upstream end of the neck body 101. The fuel supply opening 105 is closed by a fuel cap 106. The neck body 101 is formed integrally with a filler pipe (not shown). The filler pipe communicates with a fuel tank. A flange 102, an engagement dent 107 and an O-ring groove 111 are formed on the outer peripheral surface of the neck body 101. The flange 102 is fixed to a bottom wall 112 of an inlet box.

The retainer 103 is bent over at the fuel supply opening 105, and is thereby formed as a dual cylinder shape. Specifically, the retainer 103 is provided with an outer-peripheral cylinder 109 and an inner-peripheral cylinder 110. The outer-peripheral cylinder 109 is provided with an engagement claw 108 which is formed by bending. The engagement claw 108 is fitted into and engaged with the engagement dent 107 of the neck body 101. Thus, the retainer 103 is fixed to the neck body 101 by the engagement.

The O-ring 104 is disposed between the bottom surface of the groove 111 and the inner peripheral surface of the outer-peripheral cylinder 109. The O-ring 104 contacts with the bottom surface and the inner peripheral surface elastically. The tightening allowance of the O-ring 104 secures a sealing property between the neck body 101 and the retainer 103.

However, the conventional filler neck illustrated in FIG. 8 might not secure a sealing property at low temperatures. Namely, the resin forming the neck body 101 exhibits a linear expansion coefficient greater than the linear expansion coefficient of the metal forming the retainer 103. Accordingly, the thermal contraction of the neck body 101 is greater than the thermal contraction of the retainer 103 at low temperatures. The thermal contraction difference results in enlarging the gap between the inner peripheral surface of the outer-peripheral cylinder 109 and the outer peripheral surface of the neck body 101. Consequently, the O-ring 104 exerts a lesser elastic-contacting force to the bottom surface of the groove 111 and the inner peripheral surface of the outer-peripheral cylinder 109. In other words, the tightening allowance of the O-ring 104 diminishes. As a result, fuels might leak out into the air through the gap between the neck body 101 and the retainer 103 at low temperatures. Thus, the conventional filler neck illustrated in FIG. 8 might not secure a sealing property at low temperatures.

### SUMMARY OF THE INVENTION

The present invention has been developed and completed in view of the aforementioned problems. It is therefore an object of the present invention to provide a filler neck which can secure a sealing property between a neck body and a retainer even at low temperatures.

A filler neck according to the present invention can achieve the object, and comprises:

a neck body made from resin, having an upstream end, a fuel supply opening opened at the upstream end, the fuel supply opening being opened and closed by a fuel cap, a downstream end communicating with a fuel tank, an outer peripheral surface, an inner peripheral surface, and a flange disposed on the outer peripheral surface and being fixed to a vehicle-side member;

a retainer made of metal, having an engagement portion and an outer peripheral surface, the engagement portion engaged with the neck body, and fastened to the fuel cap; and

a sealing member securing a sealing property between the neck body and the retainer, and disposed between the inner peripheral surface of the neck body and the outer peripheral surface of the retainer.

In short, the present filler neck comprises the resinous neck body, the metallic retainer, and the sealing member. The sealing member is disposed between the inner peripheral surface of the neck body and the outer peripheral surface of the retainer. Specifically, the constituent parts of the present filler neck are disposed in the order of the neck body, the sealing member and the retainer from the outer-peripheral side of the present filler neck to the diametrically-inner side thereof.

The constituent parts of the present filler neck contract thermally at low temperatures, respectively. The thermal contraction of the respective constituent parts is herein in proportion to the linear expansion coefficient exhibited by the respective constituent parts. Note that the linear expansion coefficient of the resin making the neck body is greater than the linear expansion coefficient of the metal making the retainer. Therefore, the neck body contracts thermally more greatly than the retainer does. Hence, the gap between the inner peripheral surface of the neck body and the outer peripheral surface of the retainer diminishes at low temperatures.

Note that the sealing member is disposed in the gap. Therefore, the sealing member is further compressed by the inner peripheral surface of the neck body and the outer peripheral surface of the retainer when the gap diminishes. Hence, the tightening allowance of the sealing member enlarges.

Thus, in the present filler neck, the neck body is disposed on the outer-peripheral side of the sealing member, and the retainer is disposed on the inner-peripheral side of the sealing member, respectively. Accordingly, the present filler neck takes advantage of the linear expansion coefficient difference between resins and metals, which has been posing problems, adversely, so to speak. In accordance with the present filler neck, the lower the ambient temperature is, the greater the tightening allowance of the sealing member enlarges. Consequently, it is possible to fully secure a sealing property between the neck body and the retainer even at low temperatures.

In the present filler neck, the engagement portion of the retainer and the sealing member can preferably be disposed closer to the fuel tank than the flange of the neck body.

The present filler neck is fixed to a vehicle-side member, for example, to the bottom wall 112 of the inlet box as in the above-described conventional filler neck illustrated in FIG. 8. Therefore, the upstream portions beyond the flange of the neck body protrude outside vehicles. On the other hand, the downstream portions below the flange of the neck body are disposed inside vehicles. Moreover, component parts, such as a filler pipe and a fuel tank, are connected integrally or disposed independently on the downstream side of the present filler neck.

When fuel tanks are swung by certain drawbacks inside vehicles, the present filler neck is subjected to tensile loads from the inside of vehicles. Since the present filler neck is fixed to the vehicle-side member by the flange of the neck body, the flange might put the filler neck into such a state that the filler neck is suspended from the flange.

When the neck body is subjected to tensile loads which exceed a predetermined value, only the downstream portions below the flange might be dragged into vehicles while the upstream portions above the flange are left outside vehicles. To put it differently, the neck body might be broken.

If such is the case, when the sealing member is disposed on an upstream side with respect to the flange, the sealing member might also be left outside vehicles together with the upstream portions of the broken neck body. Therefore, if the neck body should be broken, it might be difficult to secure a sealing property between the neck body and the retainer.

Moreover, when the engagement portion is disposed on an upstream side with respect to the flange, the retainer might also be left outside vehicles together with the upstream portions of the broken neck body. Therefore, if the neck body should be broken, it might be difficult after all to secure a sealing property between the neck body and the retainer.

On the other hand, in the present filler neck, the sealing member and the engagement portion can be disposed adjacent to fuel tanks than the flange is. In other words, the sealing member and the engagement portion can be disposed on a downstream side with respect to the flange. Therefore, even if the neck body should be broken so that the upstream portions above the flange are left outside vehicles, it is possible to drag the sealing member and the engagement portion into vehicles together with the other downstream portions. As a result, even if the downstream portions of the neck body should be dragged into vehicles, it is possible to secure a sealing property between the neck body and the retainer.

Note that the conventional filler neck 100 illustrated in FIG. 8 is provided with a sealing member (e.g., O-ring 104) and an engagement portion (e.g., an engagement claw 108) which are disposed on an upstream side with respect to a flange 102. However, the conventional filler neck 100 is provided with a fragile portion 113 which is disposed in the flange 102 in order to secure a sealing property between the neck body 101 and the retainer 103 even after the conventional filler neck 100 is dragged into vehicles. When the conventional filler neck 100 is subjected to tensile loads which exceed a predetermined value, the fragile portion 113 breaks up quickly. As a result, it is possible to keep the inner-peripheral portions inside the fragile portion 131 from breaking, and to drag them into vehicles together with the rest of the conventional filler neck 100 from which the portion outside the fragile portion 113 is removed. Thus, the conventional filler neck 100 secures a sealing property between the neck body 101 and the retainer 103 after it is dragged into vehicles, though the O-ring 104 and the engagement claw 108 are disposed on an upstream side with respect to the flange 102.

However, in the conventional filler neck 100, it is needed to form the fragile portion 113 in the flange 102. The fragile portion 113 is required to break quickly when the flange 102 is subjected to tensile loads which exceed a predetermined value. Accordingly, it is difficult considerably to skillfully design and fabricate the shapes and thickness of the fragile portion 113. Moreover, it is necessary to assemble the flange 102 with the utmost care and attention so as not to break the fragile portion 113.

On the contrary, in accordance with the present invention, it is not needed at all to daringly provide the present filler neck with the fragile portion 113 which is not only difficult to masterly design and fabricate but also tiresome to assemble. Therefore, in accordance with the present invention, it is possible to simplify the construction of the present filler neck. Moreover, it is possible to assemble the present filler neck with ease.

In the present filler neck, the sealing member can preferably comprise an O-ring which contacts elastically with the inner peripheral surface of the neck body and the outer peripheral surface of the retainer.

As described above, the linear expansion coefficient of the resin making the neck body is greater than the linear expansion coefficient of the metal making the retainer. Accordingly, at elevated temperatures, the thermal expansion of the outer-periphery neck body is greater than the thermal expansion of the inner-periphery retainer. Therefore, at high temperatures, the gap between the inner peripheral surface of the neck body and the outer peripheral surface of the retainer enlarges. Moreover, the neck body is swollen by fuels, but the retainer is hardly swollen by fuels. Consequently, due to the swell by fuels, the gap between the inner peripheral surface of the neck body and the outer peripheral surface of the retainer enlarges similarly.

However, in the present filler neck, the O-ring can be disposed between the inner peripheral surface of the neck body and the outer peripheral surface of the retainer with a tightening allowance given in advance. Moreover, the thermal expansion and fuel swelling of the O-ring are greater than the thermal expansion and fuel swelling of the neck body. Therefore, even at elevated temperatures, the sealing property between the neck body and the retainer little degrades. Thus, in accordance with the present invention, it is possible to secure a sealing property between the inner peripheral surface of the neck body and the outer peripheral surface of the retainer not only at low temperatures but also at high temperatures.

In the present filler neck, the neck body can preferably further have an engagement dent formed in the inner peripheral surface; and the engagement portion of the retainer can preferably comprise an engagement claw fitted into and engaged with the engagement dent. In accordance with the present invention, it is possible to assemble the retainer with the neck body by simply fitting the engagement claw into the engagement dent. Moreover, it is possible to position the neck body with respect to the retainer or vice versa by simply agreeing the position of the engagement dent with the position of the engagement claw or vice versa.

A filler neck according to another aspect of the present invention can achieve the object as well, and comprises:

a neck body made from resin, having an upstream end, a fuel supply opening opened at the upstream end, the fuel supply opening being opened and closed by a fuel cap, a downstream end communicating with a fuel tank, an outer peripheral surface, an inner peripheral surface, and a flange disposed on the outer peripheral surface and being fixed to a vehicle-side member;

a retainer made of metal, having an engagement portion and an outer peripheral surface, the engagement portion engaged with the neck body, and fastened to the fuel cap; and

a sealing unit securing a sealing property between the neck body and the retainer, and disposed between the inner peripheral surface of the neck body and the outer peripheral surface of the retainer;

the engagement portion of the retainer and the sealing unit being disposed closer to the fuel tank than the flange of the neck body.

Specifically, the modified present filler neck comprises the sealing unit disposed between the inner peripheral surface of the neck body and the outer peripheral surface of the retainer. Moreover, the engagement portion of the retainer and the sealing unit are disposed closer to the fuel tank than the flange of the neck body.

In the modified present filler neck, the sealing unit secures a sealing property between the neck body and the retainer. Accordingly, it is not needed to separately dispose an independent sealing member. Therefore, the modified present filler neck can comprise constituent elements in a reduced quantity. Moreover, the assembly of the modified present filler neck can be completed simultaneously with the formation of the sealing unit. Consequently, the modified present filler neck can be assembled with reduced assembly man-hour requirements.

In accordance with the present invention, it is thus possible to provide a filler neck which can secure a sealing property between a neck body and a retainer even at low temperatures.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 is an axial cross-sectional view of a filler neck according to Example No. 1 of the present invention;

FIG. 2 is an enlarged cross-sectional view around an O-ring in the filler neck according to Example No. 1 which is subjected to low temperatures;

FIG. 3 is an enlarged cross-sectional view around the O-ring in the filler neck according to Example No. 1 which is subjected to high temperatures;

FIG. 4 is an enlarged cross-sectional view around the O-ring in the filler neck according to Example No. 1 which is swollen by a fuel;

FIG. 5 is an axial cross-sectional view of a filler neck according Example No. 2 of the present invention;

FIG. 6 is an axial cross-sectional view of a filler neck according Example No. 3 of the present invention;

FIG. 7 is an axial cross-sectional view of a filler neck according Example No. 4 of the present invention; and

FIG. 8 is an axial cross-sectional view of a conventional filler neck.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLES

Hereinafter, filler necks according to examples of the present invention will be described in detail.

### Example No. 1

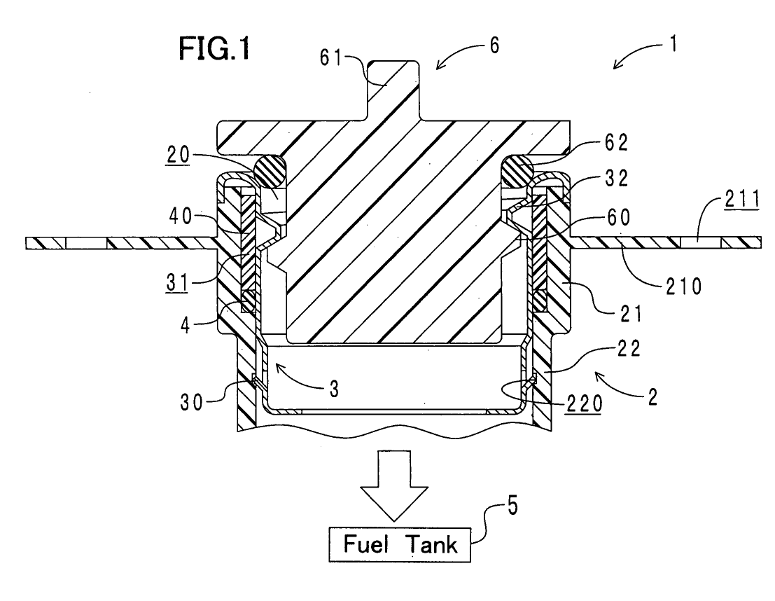

Firstly, the construction of a filler neck according to Example No. 1 will be hereinafter described. FIG. 1 illustrates an axial cross-sectional view of a filler neck 1 according to Example No. 1. As illustrated in the drawing, the filler neck 1 comprises a neck body 2, a retainer 3, and an O-ring 4.

The neck body 2 is made from polyoxymethylene resin (POM), and is formed as a shouldered cylinder shape. Specifically, the neck body 2 comprises a major-diameter portion 21, and a minor-diameter portion 22. The major-diameter portion 21 is disposed on an upstream side with respect to the minor-diameter portion 22. A fuel supply opening 20 is opened at the upstream end of the major-diameter portion 21. A ring-shaped flange 210 is formed on the outer peripheral surface of the major-diameter portion 21. Bolt holes 211 are pierced in the flange 210. The flange 210, namely, the neck body 2 is fastened to the bottom wall of an inlet box (not shown), a vehicle-side member, by bolts (not shown) which are fitted into the bolt holes 211. On the other hand, an engagement dent 220 is dented in the inner peripheral surface of the minor-diameter portion 22. Moreover, the minor-diameter portion 22 is connected with a filler pipe (not shown) at the downstream end. In addition, the filler pipe is connected with a fuel tank 5.

The retainer 3 is made of steel, and is formed as a cup shape whose bottom wall is provided with a hole. The retainer 3 is fitted into the inner-peripheral side of the neck body 2 through the fuel supply opening 20. The retainer 3 comprises an engagement claw 30. The engagement claw 30 is formed by bending, and extends from the peripheral wall of the retainer 3 outward in the diametric direction. Moreover, the engagement claw 30 is fitted into and engaged with the engagement dent 220 of the minor-diameter portion 22. Accordingly, the retainer 3 is fixed to the neck body 2. A cylinder-shaped clearance 31 is demarcated between the outer peripheral surface of the retainer 3 and the inner peripheral surface of the major-diameter portion 21. In addition, the retainer 3 further comprises a retainer-side rib 32. The retainer-side rib 32 protrudes from the inner peripheral surface of the retainer 3, and extends like a crescent shape in the peripheral direction.

The O-ring 4 is made from acrylonitrile butadiene rubber (NBR). The O-ring 4 is disposed on a downstream side with respect to the clearance 31. The O-ring 4 contacts elastically with the outer peripheral surface of the retainer 3 and the inner peripheral surface of the major-diameter portion 21. Moreover, in the clearance 31, an O-ring retainer 40 is disposed on an upstream side with respect to the O-ring 4. The O-ring retainer 40 is made from resin, and is formed as a cylinder shape. The O-ring retainer 40 inhibits the O-ring 4 from deforming to run off in the axial direction, thereby keeping the tightening allowance of the O-ring 4 from diminishing.

The fuel cap 6 is made from resin, and is formed as a short-axis cylinder shape. The fuel cap 6 comprises a cap-side rib 60. The cap-side rib 60 protrudes from the outer peripheral surface of the fuel cap 6, and extends like a crescent shape in the peripheral direction. Moreover, the fuel cap 6 further comprises a square-shaped knob 61. The square-shaped knob 61 extends upward from the upstream end of the fuel cap 6. When the fuel cap 6 is fitted into the inner-peripheral side of the retainer 3 and thereafter the knob 61 is turned by a predetermined angle, the cap-side rib 60 engages with the retainer-side rib 32. Accordingly, the fuel cap 6 is fastened to the retainer 3. When the fuel cap 6 is fastened to the retainer 3, a gasket ring 62 made from rubber secures a sealing property between the fuel cap 6 and the retainer 3.

Secondly, how the filler neck 1 according to Example No. 1 is assembled will be hereinafter described. First, the neck body 2 is manufactured by injection molding. Then, the O-ring 4 and the O-ring retainer 40 are installed around the outer peripheral surface of the retainer 3 manufactured in advance. Finally, the retainer 3 around which the O-ring 4 and the O-ring retainer 40 are installed is fitted into the inner-peripheral of the neck body 2 through the fuel supply opening 20. Thus, the filler neck 1 according to Example No. 1 is assembled.

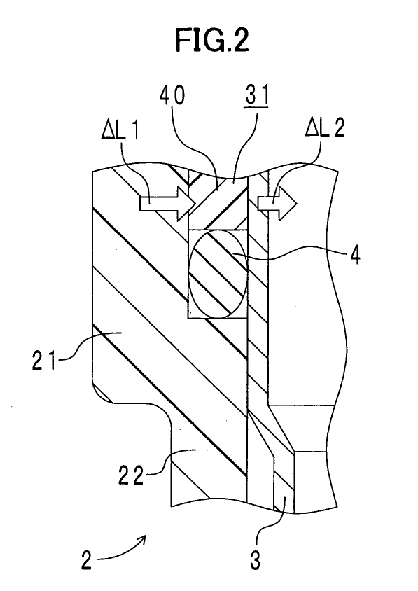

Thirdly, how the filler neck 1 according to Example No. 1 operates at low temperatures will be hereinafter described. FIG. 2 illustrates an enlarged cross-sectional view around the O-ring 4 at low temperatures. The linear expansion coefficient of POM making the neck body 2 is greater than the linear expansion coefficient of steel making the retainer 3. Accordingly, the thermal contraction ΔL1 of the neck body 2 at a low temperature is greater than the thermal contraction ΔL2 of the retainer 3 at the same low temperature. The thermal contraction difference results in the reduction of the clearance 31. Consequently, the O-ring 4 is further compressed. As a result, the tightening allowance of the O-ring 4 enlarges.

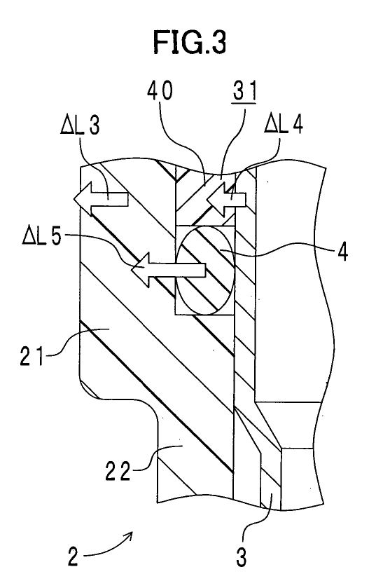

Fourthly, how the filler neck 1 according to Example No. 1 operates at elevated temperatures will be hereinafter described. FIG. 3 illustrates an enlarged cross-sectional view around the O-ring 4 at elevated temperatures. As described above, the linear expansion coefficient of POM making the neck body 2 is greater than the linear expansion coefficient of steel making the retainer 3. Accordingly, the thermal expansion ΔL3 of the neck body 2 at a high temperature is greater than the thermal expansion ΔL4 of the retainer 3 at the same high temperature. The thermal expansion difference results in the enlargement of the clearance 31.

However, the thermal expansion ΔL5 of the O-ring 4 is greater than the thermal expansion ΔL3 of the neck body 2. Consequently, the O-ring 4 is further compressed. As a result, the tightening allowance of the O-ring 4 enlarges.

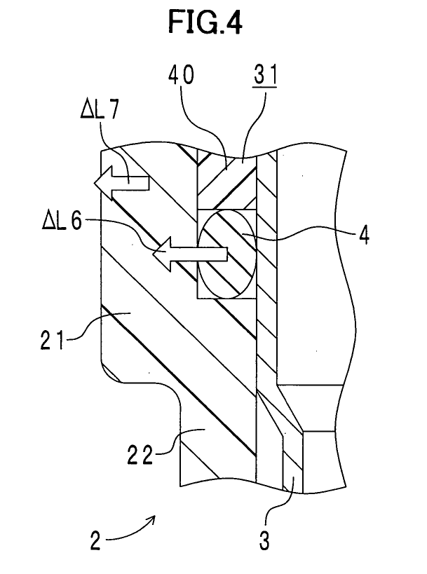

Fifthly, how the filler neck 1 according to Example No. 1 operates when it is swollen by fuels will be hereinafter described. FIG. 4 illustrates an enlarged cross-sectional view around the O-ring 4 when the filler neck 1 is swollen by fuels. The neck body 2 is swollen by fuels. On the contrary, the retainer 3 is hardly swollen by fuels. The fuel swelling difference results in the enlargement of the clearance 31.

However, the fuel swelling ΔL6 of the O-ring 4 is greater than the fuel swelling ΔL7 of the neck body 2. Accordingly, the O-ring 4 is further compressed. As a result, the tightening allowance of the O-ring 4 enlarges.

Sixthly, how the filler neck 1 according to Example No. 1 operates if the neck body 2 should be broken will be hereinafter described. As can be appreciated from FIG. 1, if the fuel tank 5 is swung in vehicles by a certain accident, tensile loads are applied to the filler neck 1 from the inside of vehicles by way of the filler pipe. Note that the filler neck 1 is fixed to the bottom wall of the inlet box by bolts. Hence, the filler neck 1 might be put into a state that it is like being suspended by the flange 210.

When the neck body 2 is subjected to tensile loads which exceed a predetermined value, the downstream portions below the flange 210 might be dragged into vehicles while the upstream portions above the flange 210 are left outside vehicles. To put it differently, the neck body 2 might be broken.

However, in the filler neck 1 according to Example No. 1, the O-ring 4 and the engagement claw 30 are disposed closer to the fuel tank 5 than the flange 210 is. Therefore, even if the neck body 2 should be broken so that the upstream portions above the flange 210 are left outside vehicles, the O-ring 4 and the engagement claw 30 are dragged into vehicles together with the rest of the downstream portions.

Finally, how the filler neck 1 according to Example No. 1 effects advantages will be hereinafter described. As shown in FIG. 2, in the filler neck 1 according to Example No. 1, the tightening allowance of the O-ring 4 enlarges at low temperatures. Therefore, it is possible to secure a sealing property between the neck body 2 and the retainer 3 even at low temperatures.

Further, as shown in FIG. 3, in the filler neck 1 according to Example No. 1, the tightening allowance of the O-ring 4 enlarges as well at elevated temperatures. Therefore, it is possible to secure a sealing property between the neck body 2 and the retainer 3 even at high temperatures.

Furthermore, in the filler neck 1 according to Example No. 1, the O-ring 4 and the engagement claw 30 are disposed closer to the fuel tank 5 than the flange 210 is. As a result, even if the neck body 2 should be broken, it is possible to secure a sealing property between the neck body 2 and the retainer 3.

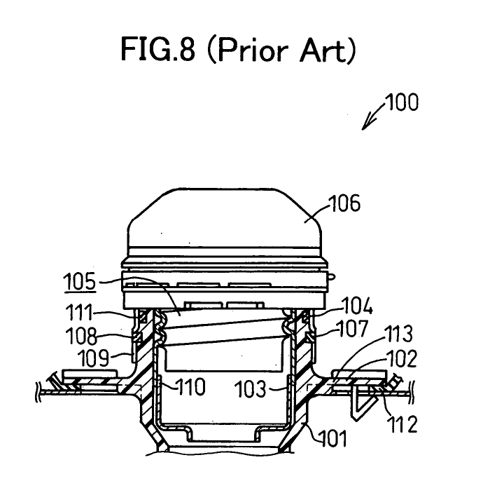

Moreover, in the filler neck 1 according to Example No. 1, it is possible to secure a sealing property between the neck body 2 and the retainer 3 even after the O-ring 4 and the engagement claw 30 should be dragged into vehicles together with the rest of the downstream portions without disposing the fragile portion 113 illustrated in FIG. 8. Specifically, it is not needed at all to daringly provide the filler neck 1 with the fragile portion 113 which is not only difficult to skillfully design and fabricate but also tiresome to assemble. Therefore, the filler neck 1 can be constructed relatively simply. Moreover, the filler neck 1 can be assembled with ease.

In addition, in the filler neck 1 according to Example No. 1, the retainer 3 can be assembled with the neck body 2 by simply fitting the engagement claw 30 into the engagement dent 220. Moreover, the neck body 2 can be positioned with respect to the retainer 3 or vice versa by simply agreeing the position of the engagement dent 220 with the position of the engagement claw 30 or vice versa. Therefore, the filler neck 1 can be assembled with ease.

Still further, in the filler neck 1 according to Example No. 1, the neck body 2 is manufactured by injection molding. Accordingly, it is relatively easy to masterly design and fabricate the clearance 31 for disposing the O-ring 4 as well as the engagement dent 220 engaging with the engagement claw 30 on the inner peripheral surface of the neck body 2. Moreover, it is possible to upgrade the important flatness in view of securing a sealing property between the neck body 2 and the retainer 3, i.e., the flatness of the inner peripheral surface of the neck body 2.

### Example No. 2

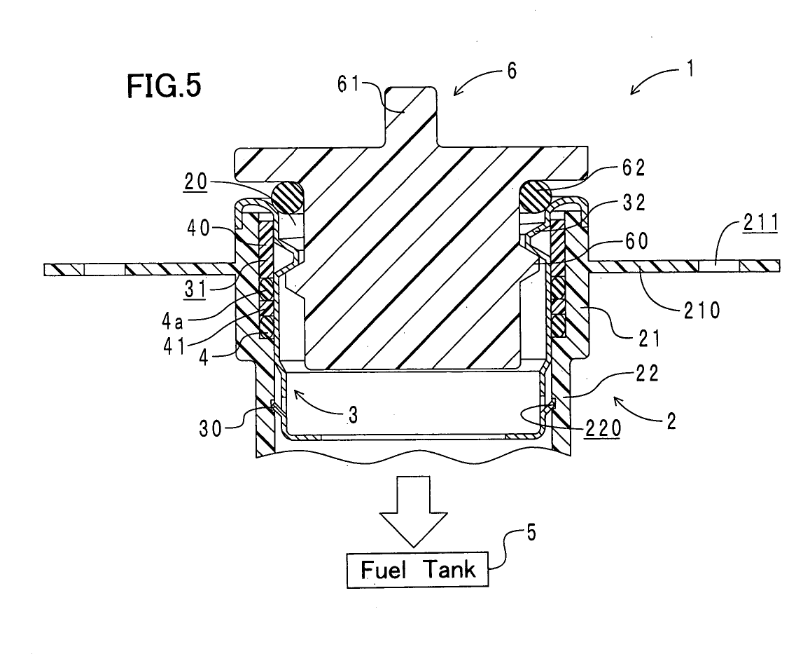

The difference between Example No. 2 and Example No. 1 is that two O-rings are disposed. Therefore, only the distinctive arrangement will be hereinafter described. FIG. 5 illustrates an axial cross-sectional view of a filler neck 1 according to Example No. 2. Note that component parts like those in FIG. 1 are designated with identical numerals.

As shown in the drawing, another O-ring 4a is disposed on the upstream side with respect to the O-ring 4 by way of a partition ring 41 made of resin. The O-ring 4a is made from NBR similarly to the O-ring 4. In the filler neck 1 according to Example No. 2, it is possible to further enhance sealing properties between the neck body 2 and the retainer 3 at low temperatures, at high temperatures, and if the neck body 2 should be broken.

### Example No. 3

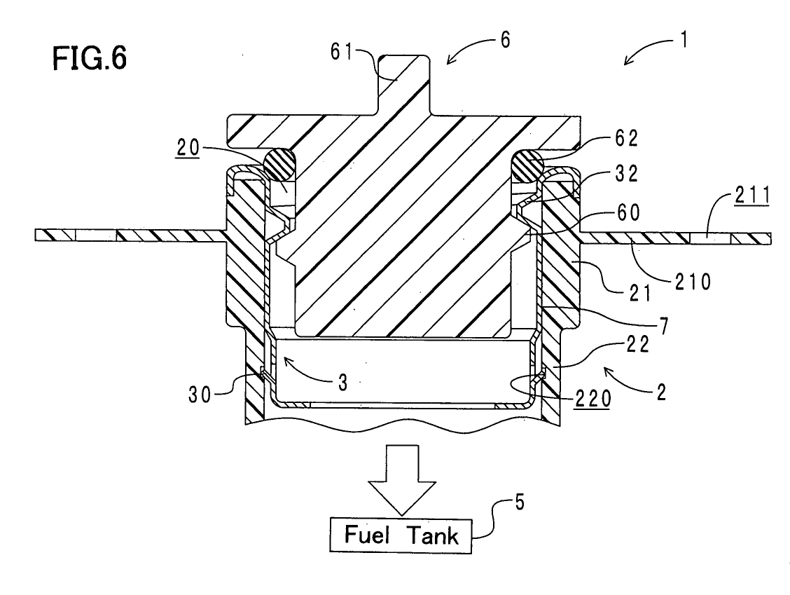

The difference between Example No. 3 and Example No. 1 is that the O-ring 4 and the O-ring retainer 40 are not disposed. Therefore, only the distinctive arrangements will be hereinafter described. FIG. 6 illustrates an axial cross-sectional view of a filler neck 1 according to Example No. 3. Note that component parts like those in FIG. 1 are designated with identical numerals.

As shown in the drawing, no clearance is demarcated between the inner peripheral surface of the neck body 2 and the outer peripheral surface of the retainer 3. A cylinder-shaped press-contacted portion 7 is formed instead between the inner peripheral surface of the neck body 2 and the outer peripheral surface of the retainer 3. Specifically, the press-contacted portion 7 is formed by press-contacting the inner periphery surface of the neck body 2 with the outer peripheral surface of the retainer 3. Note that the press-contacted portion 7 is included in the “sealing unit” set forth in the accompanying claims according to the present invention.

How the press-contacted portion 7 is fabricated will be hereinafter described. The inside diameter of the neck body 2 is designed to be slightly smaller than the outside diameter of the retainer 3. When the retainer 3 is fitted into the inner-peripheral side of the neck body 2, the neck body 2 is first heated to thermally expand. Accordingly, the inside diameter of the neck body 2 is enlarged. After the inside diameter of the neck body 2 becomes more than the outside diameter of the retainer 3, the retainer 3 is fitted into the inner-peripheral side of the neck body 2. Then, the neck body 2 and the retainer 3 are cooled as they were. Thus, the press-contacted portion 7 is manufactured. Note that the assembly of the filler neck 1 according to Example No. 3 is completed simultaneously with the manufacture of the press-contacted portion 7.

In the filler neck 1 according to Example No. 3, the press-contacted portion 7 secures a sealing property between the neck body 2 and the retainer 3. Accordingly, it is not required to dispose an O-ring as well as an O-ring retainer in the filler neck 1. Consequently, it is possible to make the filler neck 1 with a less number of component parts. Moreover, the filler neck 1 can be assembled completely simultaneously with the fabrication of the press-contacted portion 7. Therefore, it is possible to assemble the filler neck 1 with reduced assembly man-hour requirements.

### Example No. 4

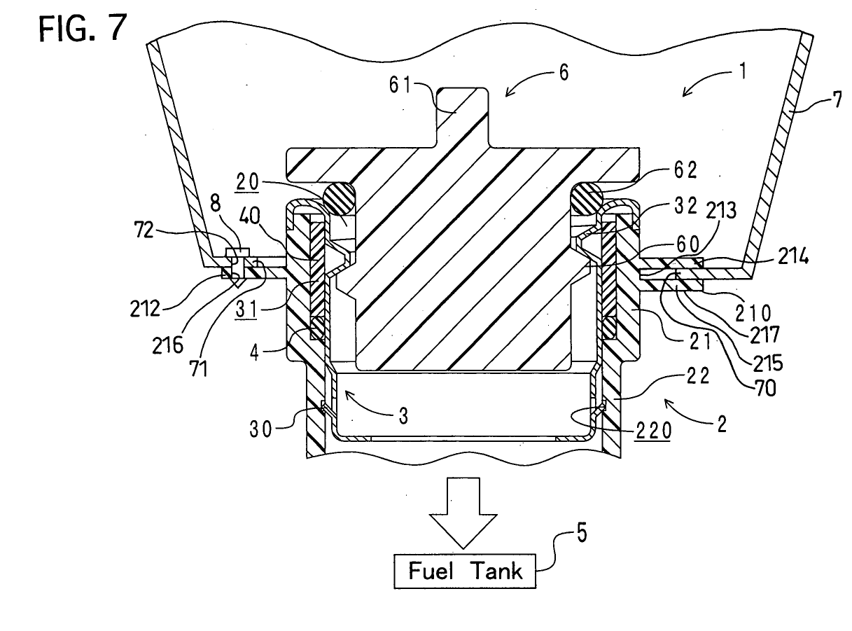

The difference between Example No. 4 and Example No. 1 is that a filler neck is assembled with an inlet box distinctively. Therefore, only the distinctive arrangements will be hereinafter described. FIG. 7 illustrates an axial cross-sectional view of a filler neck 1 according to Example No. 4. Note that component parts like those in FIG. 1 are designated with identical numerals.

As shown in the drawing, the flange 210 comprises a first arc 217, and a second arc 212. The first arc 217 is formed as a letter “U” shape in cross-section. At the periphery of the first arc 217, an engagement groove 213 is dented. Note that the engagement groove 213 can preferably be disposed over a distance of ⅓ or more of the peripheral length of the flange 210. Above and below the engagement groove 213, groove walls 214, 215 comprising an arc-shaped plate are disposed, respectively. Meanwhile, an inlet box 7 is made of metal, and is formed as a box shape opening outward. The inlet box 7 is dented in a vehicle panel (not show), and is welded to the vehicle panel. Moreover, the inlet box 7 comprises a first bottom wall 70, and a second bottom wall 71. The first bottom wall 70 and the second bottom wall 71 are made continuously. Note that a step is formed between the first bottom wall 70 and the second bottom wall 71, step which ascends in the direction from the right-hand side to the left-hand side in FIG. 7. Specifically, the second bottom wall 71 is disposed higher by one step than the first bottom wall 70. An inner periphery of the first bottom wall 70 is fitted into the engagement groove 213, and is held between the groove walls 214, 215. The second bottom wall 71 is disposed at a diagonal position with respect to the first bottom wall 70, and is provided with a box-side engagement hole 72 pierced therein.

The second arc 212 is disposed at a diagonal position with respect to the first arc 217. In the peripheral middle of the second arc 212, a flange-side engagement hole 216 is pierced. The flange-side engagement hole 216 and the box-side engagement hole 72 are disposed in series in the axial direction of the filler neck 1. Into the flange-side engagement hole 216 and box-side engagement hole 72, a nail-shaped clip 8 is press-fitted. Note that the clip 8 is made from resin, and has a diametrically-enlarged leading end.

The filler neck 1 is assembled with the inlet box 7 in the following manner. First, the filler neck 1 assembled in advance is moved closer to the inlet box 7 from down below. Second, the portions of the filler neck 1 above the grove wall 214 is protruded upward beyond the first bottom wall 70. In this instance, the top surface of the second arc 212 is brought into contact the bottom surface of the second bottom wall 71. Then, the filler neck 1 is slid in the right direction in FIG. 7 until the box-side engagement hole 72 and the flange-side engagement hole 216 are lined up in alignment with each other. When the filler neck 1 is thus slid, the first bottom wall 70 is fitted into the engagement groove 213 relatively. Thereafter, the claw-shaped clip 8 is fitted into and engaged with the box-side engagement hole 72 and the flange-side engagement hole 216 which are aligned. In accordance with the above-described procedure, the filler neck 1 is assembled with the inlet box 7.

In the filler neck 1 according to Example No. 4, the first arc 217 of the flange 210 regulates the axial movements of the filler neck 1, and the second arc 212 of the flange 210 regulates the radial movements of the filler neck 1. Moreover, the filler neck 1 can be assembled with the inlet box 7 with ease as well as at reduced cost.

### Modified Versions

The present filler neck has been described so far with reference to specific examples. However, the manner of embodying the present filler neck is not limited to the above-described examples. It is possible to achieve the present filler neck in a variety of modified or improved modes which a person having ordinary skill in the art can carry out.

For example, in the examples, the filler neck 1 is disposed independently of the filler pipe. However, the filler neck 1 can be disposed integrally with the filler pipe.

Further, in the examples, the sealing member (e.g., the O-rings 4 and 4a) or the sealing unit (e.g., the press-contacted portion 7) is disposed on an upstream side with respect to the engagement portion (e.g., the engagement claw 30). However, it is possible to reverse the disposing order.

Furthermore, in the examples, the retainer 3 is fixed to the neck body 2 by engaging the engagement claw 30 with the engagement dent 220. However, the retainer 3 can be fixed to the neck body 2 in the following manner, for example: an engagement hole can be pierced in the peripheral wall of the retainer 3; an engagement protrusion can be formed on the inner peripheral surface of the neck body 2; and the engagement protrusion can be engaged with the engagement hole. Moreover, the manufacturing method of the neck body 2 is not limited to the injection molding. For instance, the neck body 2 can be manufactured by blow molding.

Moreover, the resin making the neck body 2 is not particularly limited to POM. For example, the neck body 2 can be made from polyethylene resin (PE), polyamide resin (PA), polypropylene resin (PP), polybutylene terephthalate resin (PBT), polyethyelene terephthalate resin (PET), polyphenylene sulfide resin (PPS), polyether ketone resin (PEK) and polyether ether ketone resin (PEEK). Specifically, the neck body 2 can be made from resins which exhibit predetermined fuel-permeation resistance. Likewise, the metal making the retainer 3 is not particularly limited to steel, either.

In addition, the material making the O-ring 4, 4a is not particularly limited to NBR. For example, it is possible to manufacture the O-ring 4, 4a with polymer blends of NBR and polyvinyl chloride resin (PVC).

Still further, in Example No. 1, the filler neck 1 is assembled in the following manner: the O-ring 4 and the O-ring retainer 40 are first fitted around the outer peripheral surface of the retainer 3; and the retainer 3 is then fitted into the inner-peripheral side of the neck body 2 through the fuel supply opening 20.

However, it is possible to assemble the filler neck 1 in the following alternative manner: the O-ring 4 is fitted into the inner-peripheral side of the neck body 2 through the fuel supply opening 20; the O-ring retainer 40 is fitted into the inner-peripheral side of the neck body 2 through the fuel supply opening 20; and the retainer 3 is finally fitted into the inner-peripheral side of the neck body 2 through the fuel supply opening 20.

Having now fully described the present invention, it will be apparent to one of ordinary skill in the art that many changes and modifications can be made thereto without departing from the spirit or scope of the present invention as set forth herein including the appended claims.

What is claimed is:

1. A filler neck, comprising:
a neck body made from resin, having an upstream end, a fuel supply opening opened at the upstream end, the fuel supply opening being opened and closed by a fuel cap, a downstream end communicating with a fuel tank, an outer peripheral surface, an inner peripheral surface, and a flange disposed on the outer peripheral surface and being fixed to a vehicle-side member;
a retainer made of metal, having an engagement portion and an outer peripheral surface, the engagement portion engaged with the neck body, and fastened to the fuel cap; and
a sealing member securing a sealing property between the neck body and the retainer, and disposed between the inner peripheral surface of the neck body and the outer peripheral surface of the retainer.

2. The filler neck set forth in claim 1, wherein the engagement portion of the retainer and the sealing member are disposed closer to the fuel tank than the flange of the neck body.

3. The filler neck set forth in claim 1, wherein the sealing member comprises an O-ring which contacts elastically with the inner peripheral surface of the neck body and the outer peripheral surface of the retainer.

4. The filler neck set forth in claim 1, wherein the neck body further has an engagement dent formed in the inner peripheral surface; and the engagement portion of the retainer comprises an engagement claw fitted into and engaged with the engagement dent.

5. A filler neck, comprising:
a neck body made from resin, having an upstream end, a fuel supply opening opened at the upstream end, the fuel supply opening being opened and closed by a fuel cap, a downstream end communicating with a fuel tank, an outer peripheral surface, an inner peripheral surface, and a flange disposed on the outer peripheral surface and being fixed to a vehicle-side member;
a retainer made of metal, having an engagement portion and an outer peripheral surface, the engagement portion engaged with the neck body, and fastened to the fuel cap; and
a sealing unit securing a sealing property between the neck body and the retainer, and disposed between the inner peripheral surface of the neck body and the outer peripheral surface of the retainer;
the engagement portion of the retainer and the sealing unit being disposed closer to the fuel tank than the flange of the neck body.
